(19) United States
(12) Patent Application Publication
(10) Pub. No.: US 2008/0148022 A1
(43) Pub. Date: Jun. 19, 2008

(54) Marking registers as available for register renaming

(75) Inventors: Frederic Claude Marie Piry, Cagnes-sur-Mer (FR); Melanie Emanuelle Lucie Vincent, Grasse (FR); Florent Begon, Antibes (FR); Gilles Eric Grandou, Plascassier (FR); Norbert Bernard Eugene Lataille, Le Cannet (FR)

Correspondence Address: NIXON & VANDERHYE, PC, 901 NORTH GLEBE ROAD, 11TH FLOOR, ARLINGTON, VA, 22203, US

(73) Assignee: ARM Limited, Cambridge (GB)

(21) Appl. No.: 11/637,947

(22) Filed: Dec. 13, 2006

(51) Int. Cl. G06F 15/00

(52) U.S. Cl. 712/217

(57) ABSTRACT

The present application discloses register renaming circuitry for mapping registers from an architectural set of registers to registers within a physical set of registers, said architectural set of registers being registers specified by instructions within an instruction set and said physical set of registers being registers within a processor for processing instructions of said instruction set, said instruction set comprising exception instructions and non-exception instructions, exception instructions being instructions that may generate an exception and non-exception instructions being instructions that execute in a statically determinable way, said register renaming circuitry comprising: a first data store for storing a future renaming table, said future renaming table comprising renaming values for mapping registers from said architectural set of registers to registers in said physical set of registers for instructions that are to be executed or are currently being executed by said processor; a second data store for storing a recovery renaming table, said recovery renaming table comprising a most recently committed mapping of said processor; wherein said register renaming circuitry is responsive to detection of a predetermined condition to mark said physical registers not mapped in said recovery renaming table as available for renaming.

### BACKGROUND OF THE INVENTION

1. Field of the Invention

The field of the invention relates to data processing and in particular to register renaming in a CPU.

2. Description of the Prior Art

It is known to provide processors which process instructions from an instruction set specifying an architectural set of registers using a physical set of registers that is larger than the architectural set. This is a technique that has been developed to try to avoid resource conflicts due to instructions executing out of order in the processor. In order to have compact instruction encodings most processor instruction sets have a small set of register locations that can be directly named. These are often referred to as the architecture registers and in many ARMS (registered trade mark of ARM Ltd Cambridge UK) RISC instruction sets there will be 32 architecture registers.

When instructions are processed different instructions take different amounts of time. In order to speed up execution times, processors may have multiple execution units, or may perform out of order execution. This can cause problems if the data used by these instructions is stored in a very limited register set as a value stored in one register may be overwritten before it is used by another instruction. This leads to errors. In order to address this problem it is know for some processing cores to perform processing using more registers than are specified in the instruction set. Thus, for example, a core may have 56 physical registers to process an instruction set having 32 architecture registers. This enables a core to store values in more registers than is specified by the instruction set and can enable a value needed by an instruction that takes a long time to be executed to be stored in a physical register not used by other neighbouring instructions. In order to be able to do this the core needs to “rename” the registers referred to in the instruction so that they refer to the physical registers in the core. In other words an architectural register referred to in the instruction is remapped onto a physical register that is actually present on the core. Details of known ways of doing this can be found in “register renaming—Wikipedia”at http://en.wikipedia.org/wiki/Register_renaming.

Renaming of the registers is generally done using a renaming table or future file which maps registers from the architectural set of registers to registers in the physical set for a particular instruction. They are called future files as the renaming stage occurs before the execution stage. This can lead to potential problems in that an instruction which has been through the renaming circuitry may not execute, as it may abort or it may be on a wrongly predicted branch. For this reason each time a speculative block of instructions is known to be effectively committed, the associated future file becomes the recovery file. Thus, if a subsequent instruction aborts, there is a file showing the renaming values at a known point.

A further issue with renaming is that when an architectural register is to be mapped to a physical register it is necessary to identify which of the physical registers are available to be used for such a mapping. It is relatively straight forward to avoid WAW hazards in such a selection by keeping track of which physical register holds the latest value for an architectural register and not overwriting such a physical register. However, avoiding write after read (WAR) hazards is more difficult. Furthermore, this problem is exasperated when instructions do not complete following renaming. In such a case it is difficult to know when a physical register that has been used to map an architectural one is not required any more for that instruction and is therefore available for mapping by another architectural register. This problem is exasperated by the ARM instruction set having conditional instructions, resulting in more instructions being renamed and then not successfully executing than would be the case without conditional instructions.

One example where this problem may occur is in a multiple load operable to load a number of registers which aborts halfway through and thus does not complete. In order to regain the registers that have been mapped by the register renaming circuitry for such instructions that have not completed so that the system can mark them as available, these instructions have conventionally been “unrolled” either serially by unrolling a limited number of instructions per cycle and marking the renamed registers that are no longer needed as available which takes a lot of time, or by unrolling them in parallel which requires a lot of hardware. Failure to do this results in a register being lost to the processor. For this reason the process of marking as available registers that have been renamed but the instruction has not executed was conventionally an exact process and was expensive in either processing time or hardware.

It would be desirable to be able to improve the efficiency of this process.

### SUMMARY OF THE INVENTION

A first aspect of the present invention provides register renaming circuitry for mapping registers from an architectural set of registers to registers within a physical set of registers, said architectural set of registers being registers specified by instructions within an instruction set and said physical set of registers being registers within a processor for processing instructions of said instruction set, said instruction set comprising exception instructions and non-exception instructions, exception instructions being instructions that may generate an exception and non-exception instructions being instructions that execute in a statically determinable way, said register renaming circuitry comprising: a first data store for storing at least one future renaming table, said at least one future renaming table comprising renaming values for mapping registers from said architectural set of registers to registers in said physical set of registers for instructions that are to be executed or are currently being executed by said processor; a second data store for storing a recovery renaming table, said recovery renaming table comprising a most recently committed mapping of said processor; wherein said register renaming circuitry is responsive to detection of a predetermined condition to mark said physical registers not mapped in said recovery renaming table as available for renaming.

The present invention recognises that there are certain conditions that occur during processing where one can be sure that the only renamed registers that are required are those in the recovery table. Thus, the present invention uses this property of the system to periodically mark all registers that are not in the recovery table as available, thereby making it no longer so important if registers are lost to the processor by an instruction that is renamed and does not execute. The system therefore, no longer needs to indulge in the expensive unrolling of instructions that generate an exception, but can carry on processing and rely on the fact that at some future time a predetermined condition will occur which will allow any lost registers to be regained. Alternatively, if the situation warrants it this procedure can be performed immediately after an instruction has not completed. In such a case, instead of the conventional manner of unrolling the instruction and marking each register that was used by the instruction as available on an individual basis, all registers not in the recovery table are marked.

Furthermore, it is the register renaming logic itself that performs the step of marking the registers as available thus, it can be performed quickly and power efficiently.

It should be noted that a most recent committed mapping of the processor is a most recent mapping where there is no unresolved exception instruction pending.

The skilled person would appreciate that although a first and second data store are claimed, this is for clarity and the data store could be a single entity, for example, a bank of registers that is addressed so that a portion is for storing the recovery renaming table and another portion for storing the future table.

In some embodiments, said predetermined condition comprises said future renaming table being empty.

Embodiments of the present invention recognise that when the future renaming table is empty there aren't any speculative instructions in the pipeline and thus the recovery file is the sole representation of the system that is required. At such a point in time, only the physical registers that are listed in the recovery table are effectively needed by the system and as such any other register in the register pool can be reused. Thus, marking the other physical registers as available allows the system to regain any physical registers that may have been lost earlier in the procedure due to instructions not completing and the system therefore not realising when a renamed register has become available again.

In some embodiments said predetermined condition comprises a switch by said processor executing said instructions from a secure mode of operation to a non-secure mode of operation.

When a data processing apparatus operates in a secure mode and a non-secure mode, great care is taken not to allow data to leak between the two worlds as this can compromise the security of the system. Register renaming is a potential source of information leakage between the two worlds. For example, if one could read a register that has been “produced” in secure mode, from non-secure mode this would breach the security of the system. Proving that such cases can never happen can be difficult and thus, it can be hard to assure people of the security of a system that uses renaming. Embodiments of the invention can be used when switching from the secure mode to non-secure mode to free any registers that are not in the recovery file. This ensures that only registers in the recovery file are renamed.

In further embodiments, said register renaming circuitry is further responsive to detection of said switch from secure mode to non-secure mode, to write dummy values to said physical registers not in said recovery renaming table.

To increase security further all registers not in the recovery file can be reset by overwriting them with a dummy value. This is a robust defence against any security breach.

In some embodiments, said register renaming circuitry comprises a further data store for storing a switch value, wherein said register renaming circuitry is responsive to said switch value, and in response to said switch value having a predetermined value to monitor for said predetermined condition, and in response to said switch value not having said predetermined value to not monitor for said predetermined condition.

In some embodiments, it may be advantageous to be able to turn the present technique on and off. For example, at times it may not be needed, whereas at other times perhaps because of a bug or because of the design of the processor it may be needed. The ability to turn the technique on and off allows the continual monitoring for predetermined conditions to be turned off and power saved when the technique is not needed.

In some embodiments, said register renaming circuitry is part of a renaming stage within a processing pipeline, and is responsive to detection of no available physical registers to stall renaming, and said predetermined condition comprises any pending instructions downstream of said renaming stage that produce a register having produced said register, such that said renaming circuitry is responsive to detection of said pending instructions producing said registers to mark any physical registers not mapped in said recovery renaming table as available.

An alternative to having a switch value, or in some cases potentially an addition is to set the system so that it can deal with there being no physical registers available any more. Thus, if it occurs that there are no further physical registers available, the present technique simply stalls renaming until processing of any pending instructions downstream of the renaming stage that produce registers have produced them. At this point, it is recognised that only those registers renamed in the recovery file are required and all other registers are available. Thus, the system can simply mark all the other registers as available and can continue processing.

In some embodiments said physical registers comprise a valid bit, said register renaming circuitry being responsive to said physical registers being renamed to set said valid bit to a first predetermined value, and being responsive to said physical registers being produced to set said valid bit to a second predetermined value, said register renaming circuitry being further responsive to detection of said predetermined condition to mark said registers as being available by setting said valid bit to said second predetermined value.

Marking the registers as available can be done in a number of ways. In some embodiments, there is a valid bit which is set to a first predetermined value when the register is renamed and is set to a second predetermined value when it is produced. The system can determine which registers are available by seeing which registers are required by the pending instructions in the pipeline and also by looking to see which are produced. Those, that are renamed and are not produced i.e. have their valid bit set to a first predetermined value are never available. Thus, setting the valid bit to the second predetermined value is one way of indicating that the registers may be available. A register is produced when its stored value becomes available to subsequent instructions.

In some embodiments, said exception instructions comprise at least one of a conditional branch instruction, a load instruction and a store instruction.

Exception instructions are those that may cause a disruption in the flow in the pipeline and in these embodiments can be conditional branch instructions, load instructions or store instructions.

A second aspect of the present invention provides a data processing apparatus comprising a processing pipeline comprising: a decoder for receiving a stream of instructions from an instruction set, said decoder being configured to decode said instructions; register renaming circuitry according to a first aspect of the present invention for receiving said stream of decoded instructions from said decoder; a processor configured to receive said decoded instructions from said register renaming circuitry and configured to process said decoded instructions; said data processing apparatus further comprising a physical set of registers for storing data values being processed by said data processing apparatus.

In some embodiments, said data processing apparatus is responsive to detection of said predetermined condition to stall said processor, and said register renaming circuitry is responsive to detection of said predetermined condition to mark said registers not mapped in said renaming recovery table as available and to update said renaming future table with said renaming recovery table.

Detection of the predetermined condition can also be a trigger to stall the processor, whereupon the register renaming circuitry marks registers not mapped in the recovery table as available and updates the future table with the recovery table. It may be that the predetermined condition selected is one which shows that the processor in effect needs to be reset and at such a point the registers can be freed and the renaming table set to the recovery table. In such cases, the registers are freed immediately.

In some embodiments, said processor is stalled for three clock cycles.

In some pipelines, three cycles are required to reset conditions and free the available registers. In such embodiments, the system reacts to exception instructions where registers may be lost and frees them immediately by stalling the system for the required number of clock cycles, in this example three.

In some embodiments said data processing apparatus is responsive to a multiple load instruction aborting during processing or to a speculative processed multiple load being wrongly predicted, to mark any registers not remapped in said recovery renaming table as available and to update said renaming future table with said recovery renaming table.

One example where registers can be lost to the system is multiple load instructions not completing. Thus, in some embodiments detection of this is the trigger for the data processing apparatus to mark any registers not remapped in the recovery renaming table as available and to update the renaming future table with the recovery renaming table. By performing this operation in response to the uncompleted instruction, the potentially lost registers are regained immediately before any further instructions are processed.

A third aspect of the present invention provides a method of mapping registers from an architectural set of registers to registers within a physical set of registers, said architectural set of registers being registers specified by instructions within an instruction set and said physical set of registers being registers within a processor for processing instructions of said instruction set, said instruction set comprising exception instructions and non-exception instructions, exception instructions being instructions that may generate an exception and non-exception instructions being instructions that execute in a statically determinable way, said register renaming circuitry comprising the steps of: (i) populating a first data store with a future renaming table, said future renaming table comprising renaming values for mapping registers from said architectural set of registers to registers in said physical set of registers for instructions that are to be executed or are currently being executed by said processor; (ii) in response to an exception instruction being resolved, that is being assured to execute and not generate an exception, updating a recovery renaming table with information from said future renaming table; (iii) in response to detection of a predetermined condition, marking said physical registers not mapped in said recovery renaming table as available for renaming.

A fourth aspect of the present invention provides register renaming means for mapping registers from an architectural set of registers to registers within a physical set of registers, said architectural set of registers being registers specified by instructions within an instruction set and said physical set of registers being registers within a processing means for processing instructions of said instruction set, said instruction set comprising exception instructions and non-exception instructions, exception instructions being instructions that may generate an exception and non-exception instructions being instructions that execute in a statically determinable way, said register renaming means comprising: a first data storage means for storing a future renaming table, said future renaming table comprising renaming values for mapping registers from said architectural set of registers to registers in said physical set of registers for instructions that are to be executed or are currently being executed by said processor; a second data storage means for storing a recovery renaming table, said recovery renaming table comprising a most recently committed mapping of said processor; wherein said register renaming means is responsive to detection of a predetermined condition to mark said physical registers not mapped in said recovery renaming table as available for renaming.

### BRIEF DESCRIPTION OF THE DRAWINGS

FIG. 1 schematically shows a set of architectural registers remapping to a set of physical registers;

FIG. 2 shows a recovery table and example instruction stream;

FIG. 3 shows a pipeline according to an embodiment of the present invention;

FIG. 4 is a flow diagram giving the steps involved in updating the recovery table;

FIG. 5 shows a flow diagram showing a method according to an embodiment of the present invention;

FIG. 6 shows a flow diagram showing a method according to an alternative embodiment of the present invention; and

FIG. 7 shows a flow diagram showing a method according to another alternative embodiment of the present invention;

### DESCRIPTION OF THE PREFERRED EMBODIMENTS

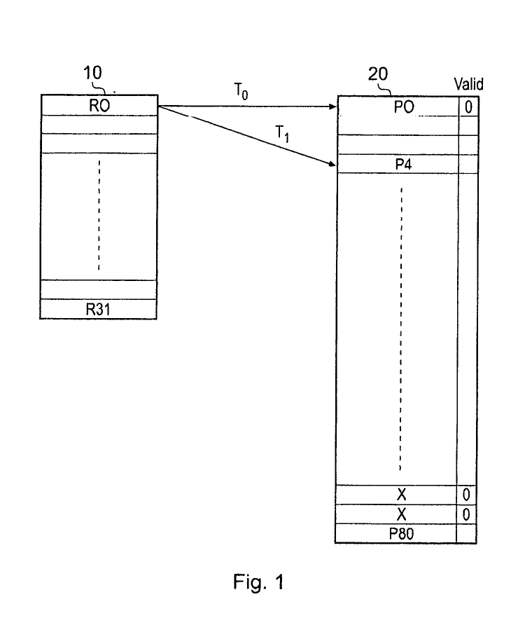

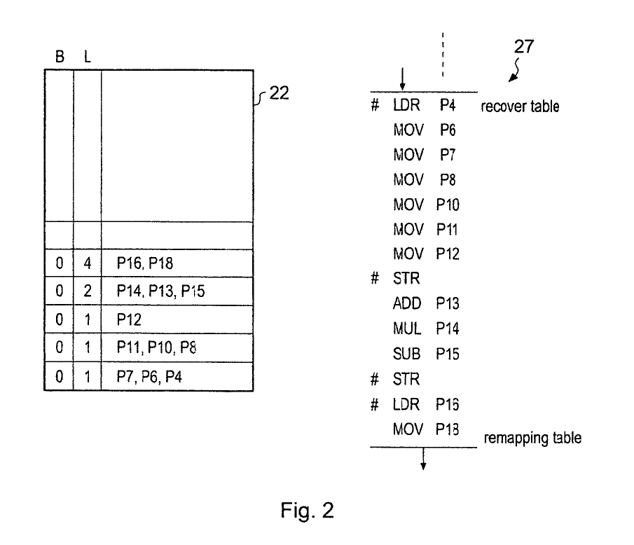

FIG. 1 schematically shows a set of architectural registers R0 to R31 being mapped to a set of physical registers P0 to P80. In register renaming a single architectural register can be mapped onto multiple physical registers, each physical register being a different view in time of this architectural register. This is shown by register R0 being mapped to register P0 at time T0 and mapped to register P4 at time T1. These different mappings are stored in structures commonly called future files, the future files representing the different mapping architectural/physical registers with time. Each time a speculative block of instructions is known to be effectively committed the associated further file becomes the “recovery” file offering the latest known stable state of the system (This is illustrated in FIG. 2).

This ability to map an architecture register to more than one of the physical registers is one way of allowing out of order processing of the instructions to be supported. Account needs to be taken of the original program instruction ordering in resolving which physical registers are referenced for a particular program instruction as it is issued.

In addition to storing the data value in the physical registers there is also a valid bit associated with these registers. When a register is renamed this valid bit is set to 0, marking the register as invalid. Then when it is produced this value is set to 1, marking the register as valid. A register is “produced” once it has made its value available to subsequent instructions. It should be noted that only registers with a 1 in the valid bit column can be available for renaming. However, having a one in the valid column is not sufficient to indicate that they are available as there may be further instructions that require the value that is written to that register. Thus, when assessing if there are available registers, logic not only analyses the value of this valid bit, but it also analyses the instructions that are pending and whether any of them require the value currently stored in this register. There are a number of known ways that logic can do this.

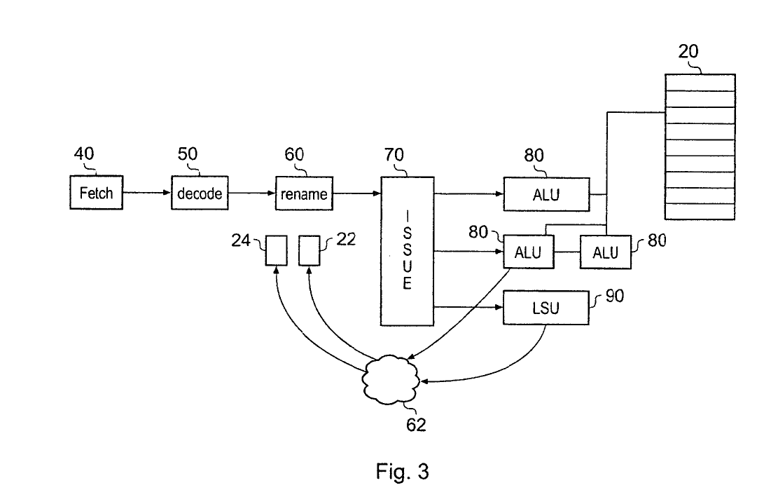

Some of the registers on this figure are marked as x and have a valid bit of 0. These are registers which have been renamed in the renaming process but are never produced in that the instruction passes through the renaming stage of the pipeline (see FIG. 3) but is not executed in the processing section of the pipeline owing to some factor. This factor could be that there is a conditional instruction whose condition is not fulfilled or it could be that the instruction aborts halfway through. If this occurs, these registers do not contain any valid value however their valid bit is set at 0 and as such they cannot be marked as available and cannot be used by the register renaming logic.

FIG. 2 shows schematically a recovery table 22, operable to store register renaming data that is needed to be able to restore a register renaming table if an exception occurs. An exception instruction is one that can cause a disruption to the flow and whose execution can therefore not be statically determined. It may be a multiple load which may abort or a multiple store or it may be an instruction that is dependent on a condition. A recovery table is required in register renaming as if an exception occurs, the system must be able to restore itself and thus a record must be kept of where values specified by architectural registers are presently stored in the physical registers. Registers in the recovery table are never marked as available and cannot be overwritten.

FIG. 2 also shows an example stream of instructions 27, this stream of instructions was decoded in the direction of the arrow (that is the instruction at the top of the list LDR P4 was decoded before MOV P6 in the instruction stream) and was then forwarded to register renaming logic, where the mapping between architectural registers and physical registers is performed, sequentially for each decoded instruction in the decoded instruction stream. The decoded instruction stream is shown as instructions with their remapped registers. Thus, P4, P6 etc. refer to physical registers present in the silicon, that the instruction shown write data values to. The portion of the instruction stream illustrated are the instructions that lie between the decoded instruction most recently remapped by the register remapping or renaming table and the decoded instruction whose remapping values are stored in the recovery or restore table. The recovery table 22 is the table holding the values of the remapping table at the last resolved exception point. The last resolved exception point being an instruction in the instruction stream that can generate an exception but that a handling unit within the processing apparatus has determined will not do so.

Thus, data relating to decoded instructions not yet remapped are not stored in buffer 10 and neither is data relating to decoded exception instructions that have been resolved.

There is also a future renaming table (not shown), that is similar in structure to the recovery table 22 and comprises the present mappings for instructions that have passed through the register renaming stage of the pipeline but have not yet executed.

Thus, they are the mappings that are used by the processor.

In the case of an exception occurring, this table can be updated with the recovery file and the instruction immediately subsequently to the last resolved exception instruction can then be reissued.

The present technique recognises that at certain points in the processing of an instruction stream it can be determined that the only registers that are not available are those in the recovery table and thus, all the other registers must be available. Thus, to address the potential problem of registers that have been marked with a valid value of 0 as they have been renamed, but are never produced as the instruction is not completed never becoming available, the present technique provides a way of marking all registers except for those in the recovery table as available at certain moments. This is done in embodiments of the invention by simply setting the valid bit to 1 for all these registers.

FIG. 3 shows an example pipeline according to embodiment of the present invention. It would be clear to a skilled person that this is an extremely schematic representation.

The pipeline comprises a fetch stage 40 where an instruction from the instruction stream is fetched, a decode stage 50 where the instruction is decoded, a renaming stage 60 where the register renaming logic lies and in which the future renaming table 24 and recovery table 22 are updated and the issue stage 70 where the instructions are issued either to ALUs 80 or to a load store unit LSU 90.

The data processing apparatus further comprises control circuitry 62. This control circuitry 62 is operable to analyse the instruction stream to identify any exception instructions. Exception instructions are those that may cause a break in instruction flow, for example they may be branch instructions or they may be load or store instructions which can abort. It also analyses instructions being processed in the execution pipelines and identifies when the exception instructions are committed, and when they generate an exception. The future table 24 and recovery table 22 can then be updated.

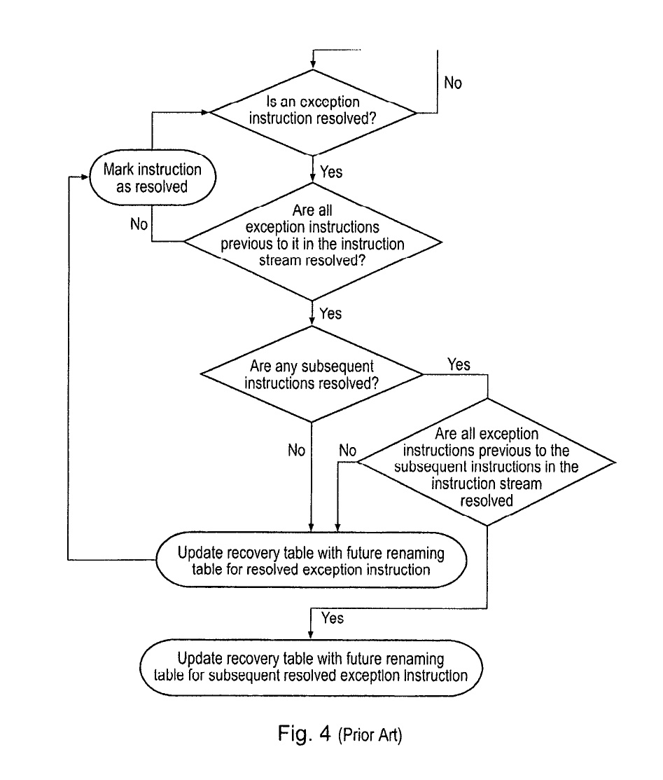

FIG. 4 is a flow diagram illustrating how the recovery table is updated. Although this does not form part of the present technique as such, it is important in that the recovery table is an important part of the present technique and this shows how it is formed. There is control logic 80 (see FIG. 3) that detects when exception instructions are resolved and updates the recovery table where appropriate. Thus, this logic initially detects whether an exception instruction is resolved. If one is it then checks to see if all previous exception instructions in the instruction stream to that exception instruction have also been resolved. This is important as register renaming is generally done in processors that perform out of order processing and thus, exception instructions can be resolved out of order in the instruction stream. If all the instructions previous to the exception instruction have not been resolved then this instruction is marked as resolved and the circuit once more detects if any exception instructions are resolved. If all the exception instructions previous to that instruction in the instruction stream have been resolved then the circuit checks to see if any subsequent exception instructions have been resolved. If there are no subsequent exception instructions resolved then the recovery table is updated with the future renaming table for the resolved exception instruction as this is the most recent point in the instruction stream that a committed stated of the processor is known. This information is saved in case there is some subsequent interruption to program flow and the state of the processor needs to be restored.

If there are subsequent exception instructions that have been resolved then it is looked to see if all exception instructions previous to the subsequent instruction have been resolved. If they have been then the recovery table is updated with the future renaming table for that subsequent resolved exception instruction as it is this exception instruction that is the latest committed point in the instruction stream and thus it is this that is recorded for potential restoration of the state of the processor. If not all the exception instructions previous to this subsequent instruction have been resolved then the recovery table is updated with the future renaming table for the previously detected resolved exception instruction.

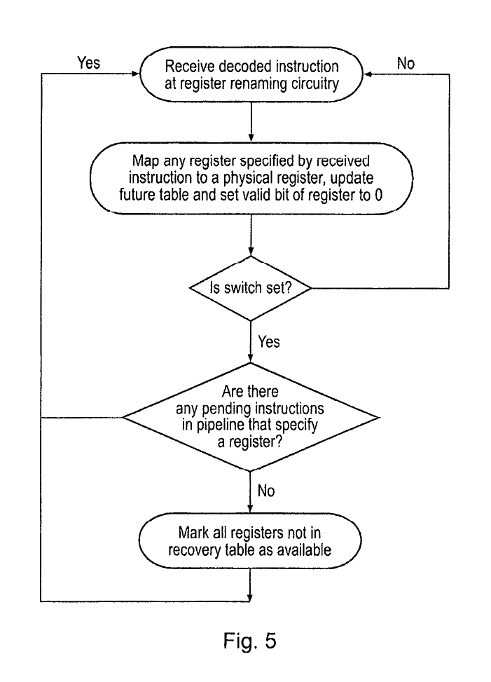

FIG. 5 illustrates a method according to one embodiment of the present invention. Initially a decoded instruction is received at register renaming circuitry. This register renaming circuitry maps any registers specified by the received instruction to physical registers present in the silicon, updates the future table with this information and sets the valid bit of the renamed registers to zero to indicate that that registers have been renamed but have not yet been produced.

The register renaming circuitry then checks to see whether a switch is set, this is generally done by seeing if a value stored in a switch bit has a predetermined value. If the switch is set then this means that the technique of gathering free registers is turned on. If this is the case, the register renaming circuitry looks to see if there are any pending instructions in the pipeline following the renaming stage that specify a register. If there aren't then all registers that are not in the recovery table must be available for renaming and as such they can be marked as available. If there are pending instructions in the pipeline that specify a register then this is not the case and the steps are repeated for the next decoded instruction.

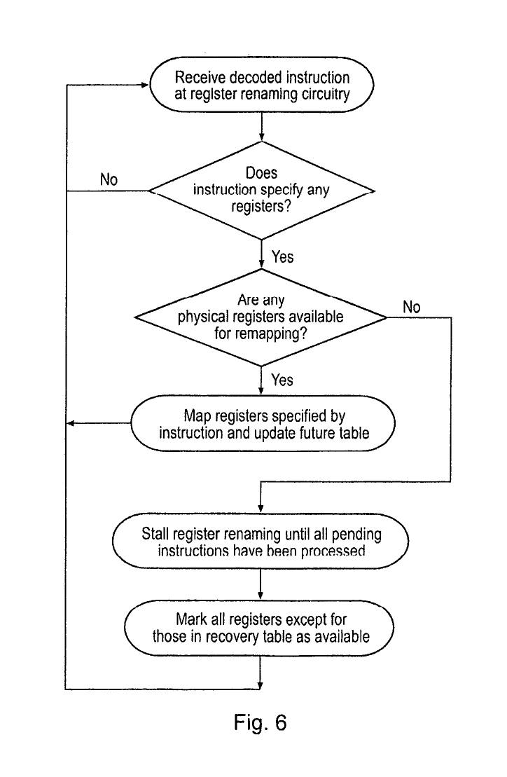

FIG. 6 shows a flow diagram indicating a further method according to an embodiment of the present invention. In this method a decoded instruction is received at register renaming circuitry and it is determined whether or not the instruction specifies any registers. If it does not then the next instruction is looked at. If it does then the method looks to see if any physical registers are available for remapping. If there are some available then the registers specified by the instruction are mapped to the available physical registers and the future table is updated. If there are no physical registers available then the register renaming is stalled until all pending instructions have been processed. At this point you can be sure that all registers except for those specified in the recovery table are available and thus all registers can be marked as available before receiving the next decoded instruction. Thus, any registers that have been renamed but the instructions they are associated with have not executed are in effect freed and there are no more registers that are currently lost to the system. By using the condition of there being no physical registers available to the system, this technique is only performed when it is really needed, and the system will always be able to find registers. A drawback is that the system must stall and wait for any pending instructions to complete.

It should be noted that although in this embodiment the register renaming stage is stalled until all pending instructions have been processed it is not strictly necessary to stall the register renaming stage for this long. In reality provided that all pending instructions that produce registers have produced them, then the system can be sure that all other registers apart from those in the recovery table are available for renaming. Thus, in other embodiments the register renaming stage is simply stalled until all instructions downstream of the renaming stage that produce a register having produced their registers.

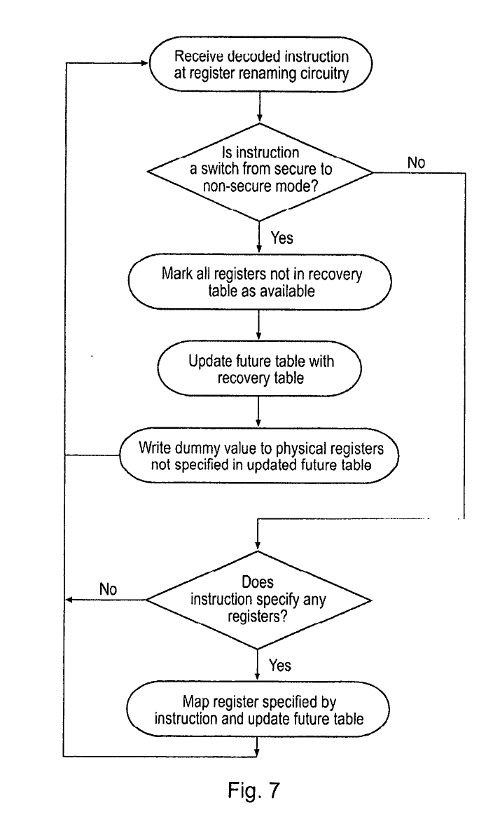

FIG. 7 illustrates an embodiment of the present invention that can be applied to switching between secure and non-secure modes to improve the security of the system.

An instruction is received at register renaming circuitry and it is looked to see whether this instruction involves a switch from secure to non-secure mode. If it does then all registers not in the recovery table are marked as available, the future table is updated with the recovery table and dummy values are written to the physical registers not specified in the updated future table. Thus, all registers are free and the only registers to hold data are those in the updated future table. This reduces the risk of data that has been written to a register in the secure mode becoming available to the non-secure mode. It should be noted that the three steps just recited could be performed in any order. In other words, dummy values could be written to the registers not in the recovery table prior to updating the future table with the recovery table and prior to marking all registers not in the updated recovery table as available.

If the instruction is not a switch from secure to non-secure mode then the register renaming logic operates in the normal fashion to map any specified registers.

Although illustrative embodiments of the invention have been described in detail herein with reference to the accompanying drawings, it is to be understood that the invention is not limited to those precise embodiments, and that various changes and modifications can be effected therein by one skilled in the art without departing from the scope and spirit of the invention as defined by the appended claims.

We claim:

1. Register renaming circuitry for mapping registers from an architectural set of registers to registers within a physical set of registers, said architectural set of registers being registers specified by instructions within an instruction set and said physical set of registers being registers within a processor for processing instructions of said instruction set, said instruction set comprising exception instructions and non-exception instructions, exception instructions being instructions that may generate an exception and non-exception instructions being instructions that execute in a statically determinable way, said register renaming circuitry comprising:
a first data store for storing at least one future renaming table, said at least one future renaming table comprising renaming values for mapping registers from said architectural set of registers to registers in said physical set of registers for instructions that are to be executed or are currently being executed by said processor;
a second data store for storing a recovery renaming table, said recovery renaming table comprising a most recently committed mapping of said processor; wherein said register renaming circuitry is responsive to detection of a predetermined condition to mark said physical registers not mapped in said recovery renaming table as available for renaming.

2. Register renaming circuitry according to claim 1, wherein said predetermined condition comprises no pending instruction within said processor that specifies a register.

3. Register renaming circuitry according to claim 2, wherein said predetermined condition comprises said future renaming table being empty.

4. Register renaming circuitry according to claim 1, wherein said predetermined condition comprises a switch by said processor executing said instructions from a secure mode of operation to a non-secure mode of operation.

5. Register renaming circuitry according to claim 4, wherein said register renaming circuitry is further responsive to detection of said switch from secure mode to non-secure mode, to write dummy values to said physical registers not in said recovery renaming table.

6. Register renaming circuitry according to claim 1, wherein said register renaming circuitry comprises a further data store for storing a switch value, wherein said register renaming circuitry is responsive to said switch value, and in response to said switch value having a predetermined value monitors for said predetermined condition, and in response to said switch value not having said predetermined value does not monitor for said predetermined condition.

7. Register renaming circuitry according to claim 1, wherein said register renaming circuitry is part of a renaming stage within a processing pipeline, and is responsive to detection of no available physical registers to stall renaming, and wherein said predetermined condition comprises any pending instructions downstream of said renaming stage that produce a register having produced said register, such that said renaming circuitry is responsive to detection of said pending instructions producing said registers to mark any physical registers not mapped in said recovery renaming table as available.

8. Register renaming circuitry according to claim 1, wherein said physical registers comprise a valid bit, said register renaming circuitry being responsive to said physical registers being renamed to set said valid bit to a first predetermined value, and being responsive to said physical registers being produced to set said valid bit to a second predetermined value, said register renaming circuitry being further responsive to detection of said predetermined condition to mark said registers as being available by setting said valid bit to said second predetermined value

9. Register renaming circuitry according to claim 1, wherein said exception instructions comprise at least one of a conditional branch instruction, a load instruction and a store instruction.

10. A data processing apparatus comprising a processing pipeline comprising:
a decoder for receiving a stream of instructions from an instruction set, said decoder being configured to decode said instructions;
register renaming circuitry according to claim 1 for receiving said stream of decoded instructions from said decoder;
a processor configured to receive said decoded instructions from said register renaming circuitry and configured to process said decoded instructions; said data processing apparatus further comprising
a physical set of registers for storing data values being processed by said data processing apparatus.

11. A data processing apparatus according to claim 10, wherein said data processing apparatus is responsive to detection of said predetermined condition to stall said processor, and said register renaming circuitry is responsive to detection of said predetermined condition to mark said registers not mapped in said renaming recovery table as available and to update said renaming future table with said renaming recovery table.

12. A data processing apparatus according to claim 10, wherein said processor is stalled for three clock cycles.

13. A data processing apparatus according to claim 10, wherein said data processing apparatus is responsive to a multiple load instruction aborting during processing or to a speculative processed multiple load being wrongly predicted, to mark any registers not remapped in said recovery renaming table as available and to update said renaming future table with said recovery renaming table.

14. A method of mapping registers from an architectural set of registers to registers within a physical set of registers, said architectural set of registers being registers specified by instructions within an instruction set and said physical set of registers being registers within a processor for processing instructions of said instruction set, said instruction set comprising exception instructions and non-exception instructions, exception instructions being instructions that may generate an exception and non-exception instructions being instructions that execute in a statically determinable way, said register renaming circuitry comprising the steps of:
(i) populating a first data store with a future renaming table, said future renaming table comprising renaming values for mapping registers from said architectural set of registers to registers in said physical set of registers for instructions that are to be executed or are currently being executed by said processor;
(ii) in response to an exception instruction being resolved, that is being assured to execute and not generate an exception, updating a recovery renaming table with information from said future renaming table;
(iii) in response to detection of a predetermined condition, marking said physical registers not mapped in said recovery renaming table as available for renaming.

15. A method according to claim 14, wherein said predetermined condition comprises said future renaming table being empty.

16. A method according to claim 14, wherein said predetermined condition comprises a switch by said processor executing said instructions from a secure mode of operation to a non-secure mode of operation.

17. A method according to claim 16, comprising a further step of writing dummy values to said physical registers marked as available.

18. A method according to claim 14, wherein step (iii) is performed in response to a switch value stored in a further data store having a predetermined value and in response to detection of said predetermined condition.

19. A method according to claim 14, comprising a further step (iia) performed before step (iii) of in response to detection of no available physical registers, stalling renaming until detection of completion of processing of any pending instructions downstream of a renaming stage in a processing pipeline, and wherein completion of processing of said pending instructions comprising said predetermined condition, such that step (iii) is performed in response to it.

20. A method according to claim 14, said method further comprising the step of detecting if a register has been produced and removing said register mapping from said future table in response to said register being produced, and wherein said physical registers comprise a valid bit, said method comprising the steps of setting said valid bit to a first predetermined value in response to said register being renamed, and setting said valid bit to a second predetermined value in response to said register being produced, said register renaming circuitry marking said registers as available in step (iii) by setting said valid bit to said second predetermined value

21. Register renaming means for mapping registers from an architectural set of registers to register within a physical set of registers, said architectural set of registers being registers specified by instructions within an instruction set and said physical set of registers being registers within a processing means for processing instructions of said instruction set, said instruction set comprising exception instructions and non-exception instructions, exception instructions being instructions that may generate an exception and non-exception instructions being instructions that execute in a statically determinable way, said register renaming means comprising:
a first data storage means for storing a future renaming table, said future renaming table comprising renaming values for mapping registers from said architectural set of registers to registers in said physical set of registers for instructions that are to be executed or are currently being executed by said processor;
a second data storage means for storing a recovery renaming table, said recovery renaming table comprising a most recently committed mapping of said processor; wherein
said register renaming means is responsive to detection of a predetermined condition to mark said physical registers not mapped in said recovery renaming table as available for renaming.
